(19) United States
(12) Patent Application Publication
(10) Pub. No.: US 2025/0345922 A1
(43) Pub. Date: Nov. 13, 2025

(54) ROTATABLE AND HEIGHT-ADJUSTABLE DOOR PAINTING ASSEMBLY

(71) Applicant: Kyle Robinson, Menlo Park, CA (US)

(72) Inventors: Kyle Robinson, Menlo Park, CA (US); Michael Elwell, Kalamazoo, MI (US)

(21) Appl. No.: 19/277,525

(22) Filed: Jul. 23, 2025

(51) Int. Cl. B25H 1/02

(52) U.S. Cl. CPC B25H 1/02

(57) ABSTRACT

A door painting assembly is provided that allows a door mounted thereon to be rotated either by use of a foot or a hand, and allows height adjustment for the door to be painted. The door painting assembly includes a base frame. The base frame includes an outer ring and an inner ring. The outer ring is rotatably configured over the inner ring ensuring the outer ring remains centered with respect to the inner ring during rotation. The door painting assembly further includes a pole oriented upright over the outer ring, a set of linearly arranged holes, and an arm holder assembly having tubes and sleeves. The arm holder assembly is attached to a plunger assembly with a plunger. The arm holder assembly is slidable over the pole to facilitate height adjustment of a door mounted over a supporting surface.

### FIELD OF THE INVENTION

The present invention relates to door painting devices, and more particularly to a door painting assembly that allows mounting/supporting a door thereon and a painter to rotate the door and adjust the height of the door as needed, while painting the door.

### BACKGROUND

Painting doors, especially cabinet doors is a challenging job. Swirling air can create uneven paint coverage while painting the cabinet doors. Numerous spray tables are available, which are either hand-or-foot-operated to better and evenly spray paint on the cabinet doors. In some spray tables, turning the cabinet door turns the assembly on which the cabinet door is supported/mounted. In others, the assembly is turned using handles. SprayTwirly™ by Paintline and Spray Table from Total Finishing Supplies are two such examples of hand-operated spray tables known in the art. At times when the cabinet door or other doors being painted are substantially larger, having an option to extend the handles to achieve a larger radius is beneficial. Also at work, when turning a spray table by hand, the operator needs to touch areas with paint overspray, which can contaminate the glove worn by the operator. Turning the spray table with the foot solves this issue. Foot Operated Spray Table by Gibb Sandtech Ltd., Foot Operated Spray Table by Total Finishing Supplies, Easy|Axis Turntable by Smartech International, LP. are some examples of foot-operated spray tables known in the art. Additionally, while using such traditional spray tables to spray the cabinet doors mounted over the spray tables, overspray can gunk up the parts/components underneath the spray table. It is also desirable that the spray table, especially the underside components of the spray table be protected from the overspray.

To address these issues, the inventor herein proposes a door painting assembly or a spray table in which the door will be held substantially in a horizontal position and rotated using a foot or a hand, or both, as desired by the operator, while holding the spray gun in one of the hands. The invention also allows adjustability of the height of the door mounted/supported on a mounting/supporting surface of the door painting assembly.

### BRIEF SUMMARY

It is an objective of the present invention to provide a modular, portable, and rotatable door painting assembly that allows a door to be mounted thereon in a substantially horizontal position and enables rotation of a mounting/supporting surface of the assembly using a hand or a foot while holding a spray paint gun in the other hand.

It is an objective of the present invention to provide a door painting assembly that allows changing the height of the door mounted or supported on the door painting assembly.

It is an objective of the present invention to provide a rotatable door painting assembly that can be quickly assembled and disassembled in order to facilitate shipment of the assembly with greater ease.

Another objective of the present invention is to provide a door painting assembly in which an arm holder assembly can either use arms or a block member (Eg. MDF board) placed on top of the tubes of the arm holder assembly to facilitate secure mounting/supporting of a door to be painted over them.

Embodiments of the present invention disclose a door painting assembly. The door painting assembly includes a base frame. The base frame includes an outer ring having a top member and a first side member oriented perpendicular to the top member, and an inner ring having a bottom member and a second side member oriented perpendicular to the bottom member. The outer ring is rotatably configured over the inner ring ensuring the outer ring remains centered with respect to the inner ring during rotation.

In an embodiment, the door painting assembly includes a pole oriented upright over the outer ring comprising a first end, a second end, and a set of linearly arranged holes located in proximity to the second end. The first end of the pole embodies a flange that's attached to a disc attached on top of the pair of cross members.

In an embodiment, the door painting assembly further comprises an arm holder assembly comprising a plurality of tubes, and a plurality of sleeves both of which are suitably lasered and welded. The arm holder assembly is attached to a plunger assembly with a plunger and wherein the arm holder assembly is slidable over the pole to facilitate height adjustment of a door mounted over a mounting/supporting surface.

In an embodiment, the inner ring comprises a plurality of rotatable wheels configured onto the second side member. Each of the plurality of rotatable wheels is mounted onto the second side member using a bolt that passes through a first hole, and a lock nut that engages the bolt. The plurality of rotatable wheels are conveyor skate wheels onto which the outer ring is rotatably mounted.

In an embodiment, the inner ring comprises a plurality of rotatable bumpers configured onto the bottom member. Each of the plurality of rotatable bumpers is mounted onto the bottom member of the inner ring using a bolt that passes through a second hole, and a nut and a lock washer that engages the bolt. Each of the rotatable bumpers is mounted onto the bottom member of the inner ring enabling the outer ring to freely rotate with respect to the inner ring and ensuring the outer ring always remains centered and does not wobble during rotation.

In an embodiment, the inner ring further comprises a plurality of levelling feet each configured onto the bottom member of the inner ring to ensure the door painting assembly stands flat on an uneven surface.

In an embodiment, the outer ring further comprises a pair of cross members configured thereon. Each of the cross members is V-shaped and welded at the meeting point of two diverging arms and lasered and welded over an upper surface of the top member of the outer ring.

In an embodiment, the assembly's mounting/supporting surface for the door comprises a plurality of arms. Each arm includes a horizontal member and a vertical member with a threaded slot. The vertical member of each of the plurality of arms is insertable into the plurality of tubes of the arm holder assembly and locked in place by passing a thumb screw through a through hole provided in each of the plurality of tubes and the threaded slot. The assembly's mounting/supporting surface for the door further comprises a spike comprising a body with a plurality of legs, a magnet located underneath the body, a post with a tip (preferably latex tip) mounted onto a top surface of the body. The spike comprises a groove that enables the spike to slide over the arms and be adjusted based on the size of the door that needs painting.

In an embodiment, the door painting assembly further comprises a plurality of handles, each handle is insertable into the horizontal member of the arm and facilitates rotation of the door mounted over the mounting/supporting surface. The handle is a U-shaped rod with a wide-open free end that's inserted inside the horizontal member of the arm.

In another embodiment, the assembly's mounting/supporting surface for the door comprises a block member. comprising a plurality of notches formed underside the block member. The block member is an MDF board, and the plurality of notches receive the top end of the plurality of tubes when the MDF board is placed thereon.

These and other features and advantages along with other embodiments of the present invention will become apparent from the detailed description below, in light of the accompanying drawings.

### BRIEF DESCRIPTION OF THE ACCOMPANYING DRAWINGS

The disclosure will be better understood and objects other than those set forth above will become apparent when consideration is given to the following detailed description thereof. Such description makes reference to the annexed drawings wherein:

FIG. 1 shows a front-perspective view of a rotatable door painting assembly, according to one embodiment of the present invention.

FIG. 2 shows an exploded view of the rotatable door painting assembly of FIG. 1.

FIG. 3 shows an inner ring with associated components mounted thereon and wherein a portion of the inner ring is shown enlarged to show wheels and bumpers arranged on the inner ring, according to an embodiment.

FIG. 4 shows an arm holder assembly with arms configured onto a pole, wherein a portion of which is shown enlarged to show the mechanism by which the arm holder assembly is held on the pole, according to an embodiment.

FIG. 5 shows another view of the arm holder assembly with the arms configured thereon and door mount spikes arranged onto the arms.

FIG. 6 illustrates an exemplary arm that's configured onto the arm holder assembly as shown in FIGS. 4-5.

FIGS. 7-8 show a partial front-perspective view of a rotatable door painting assembly, according to another embodiment of the present invention.

FIG. 9 shows a bottom view of a block member configured to be placed on top of the tubes of the arm holder assembly.

FIG. 10 shows a portion of the arm holder assembly of FIG. 1 and FIG. 7, according to an embodiment.

FIGS. 11-12 show an outer ring with cross members that allows the pole to be mounted thereon.

FIG. 13 shows an enlarged portion of the rotatable door painting assembly of FIG. 1 that shows the engagement of a spike over the arm configured on the arm holder assembly.

FIG. 14 shows the rotatable door painting assembly of FIG. 1 in use, wherein a painter is seen spraying paint on a door mounted on the door painting assembly using one hand and rotating the board by rotatably pushing the handle configured within the arms in the arm holder assembly using the other hand.

FIG. 15 shows the rotatable door painting assembly of FIG. 1 in use, wherein a painter is seen spraying paint on a door mounted on the door painting assembly and rotating the board by rotating the outer ring using one of his foot.

FIG. 16 shows the rotatable door painting assembly of FIG. 1 in use, with a polybag covering the underside portions of the door painting assembly.

### DETAILED DESCRIPTION

As used in the specification and claims, the singular forms “a”, “an” and “the” may also include plural references. For example, the term “an article” may consist of a plurality of articles. Those with ordinary skill in the art will appreciate that the elements in the Figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted in one of the described drawings. In the event such a component is described, but not depicted in a drawing, the absence of such a drawing should not be considered as an omission of such design from the specification.

Before describing the present invention in detail, it should be observed that the present invention utilizes a combination of mechanical components, which constitutes a rotatable door painting assembly and associated components thereof. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open-ended in that an item or items following any one of these words is not meant to be an exhaustive listing of such item or items or meant to be limited to only the listed item or items. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above, it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

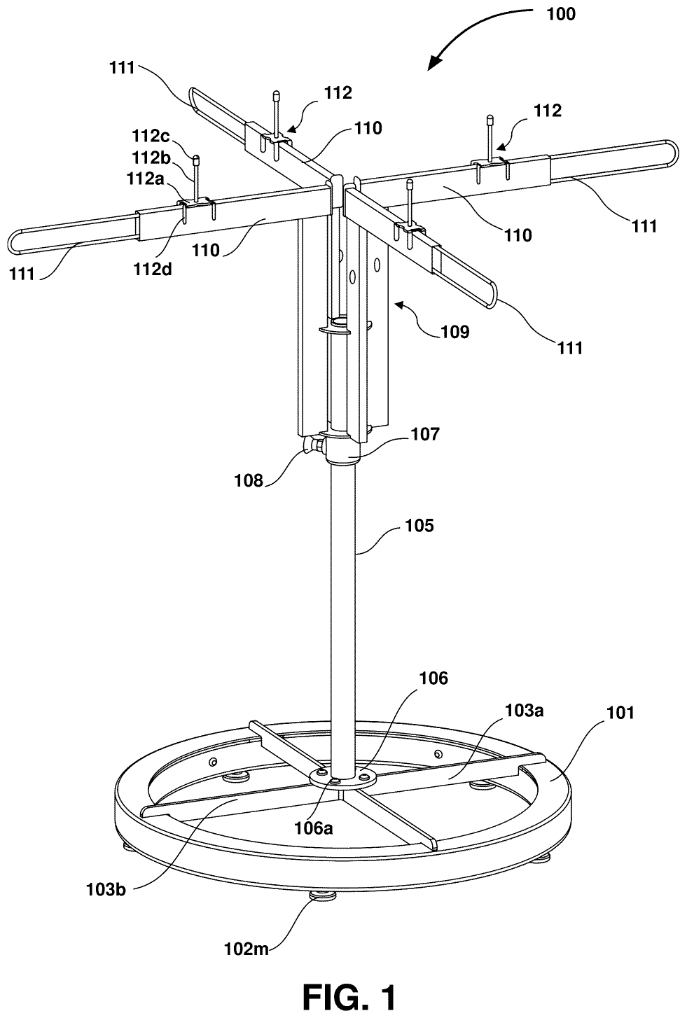

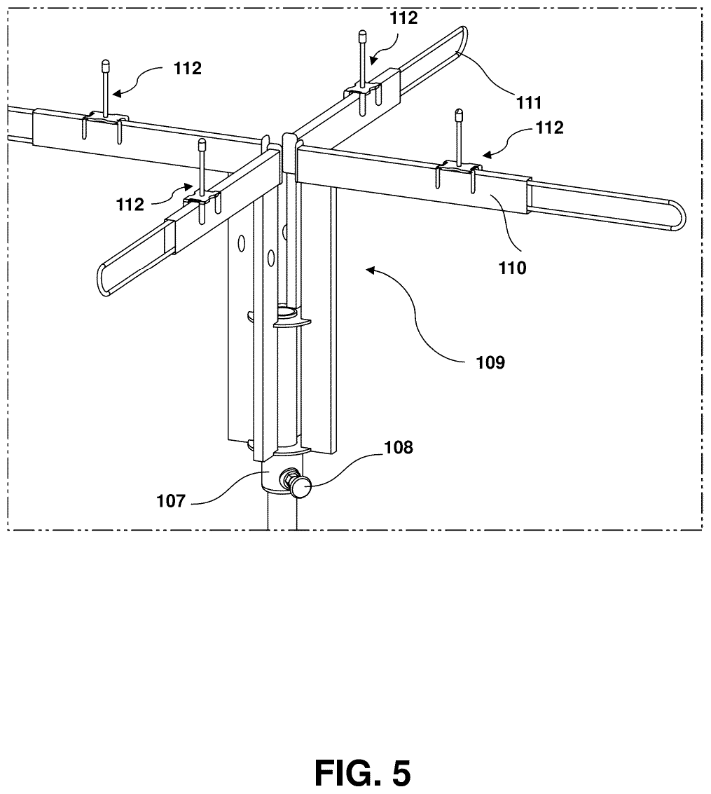

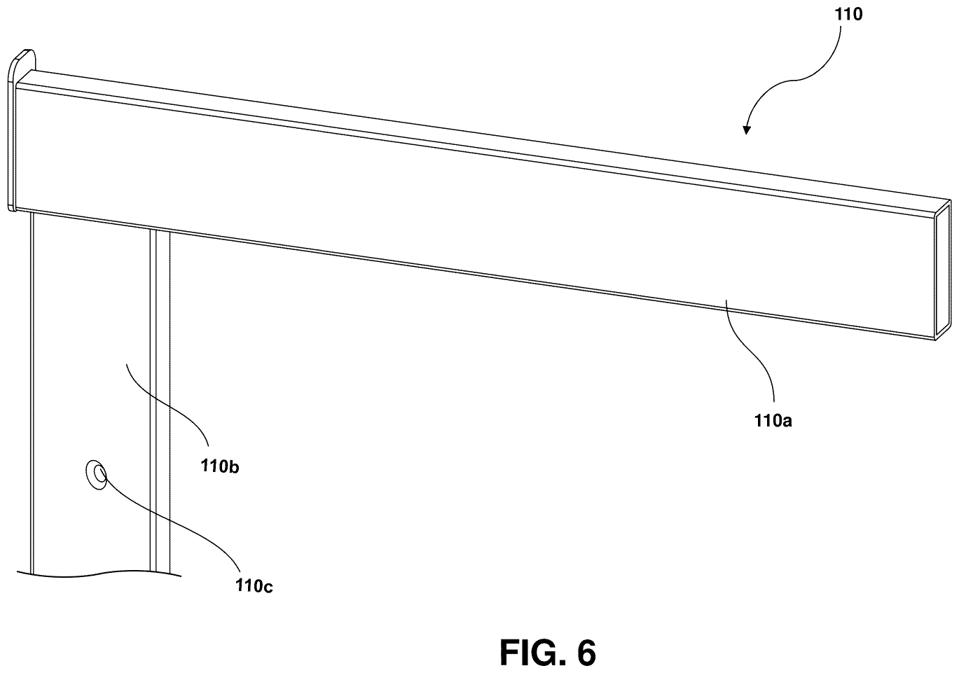

With reference now to the drawings, and in particular to FIGS. 1 through 16 thereof, a new door painting assembly embodying the principles and concepts of one or more embodiments of the disclosure and generally designated by the reference numeral 100 will be described.

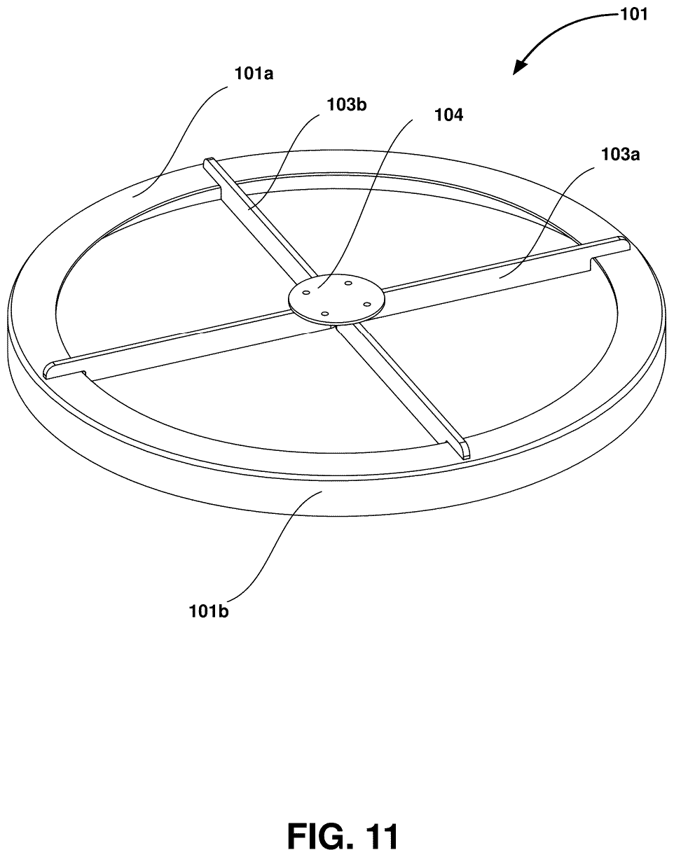

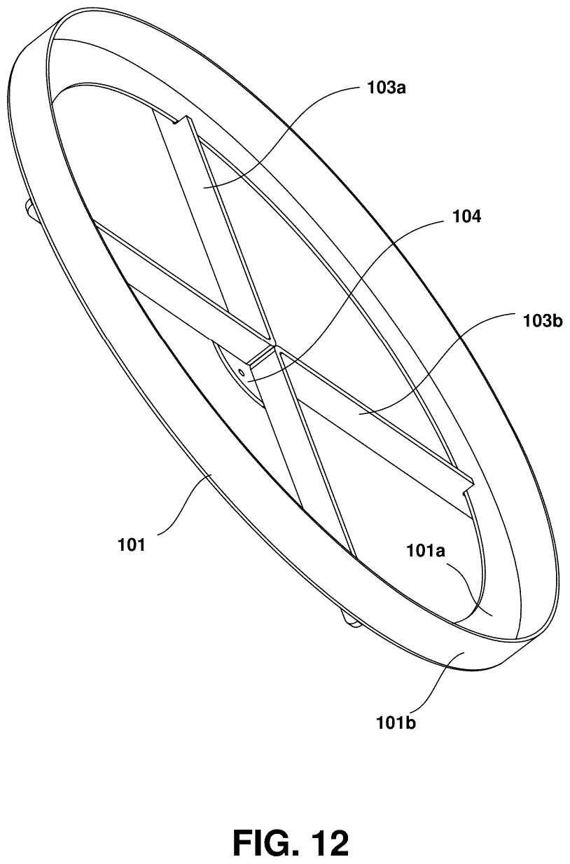

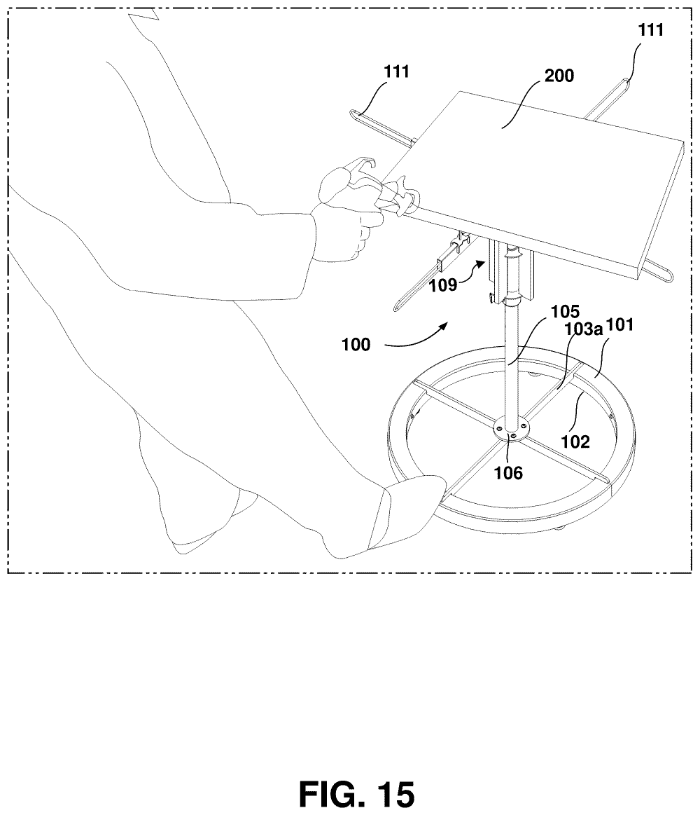

Referring to FIGS. 1-16, particularly to FIGS. 1-6 and 10-15, a door painting assembly 100 for mounting/supporting a door to be painted is shown. In the context of the present invention, although the disclosure specifically references the term “door” as an object to be painted, however it should be understood that door painting assembly 100 may be utilized for painting a large variety of objects that can be painted such as but not limited to door panels, window panels, cabinet panels. The door painting assembly 100 includes a base frame. The base frame includes an outer ring 101 and an inner ring 102. The base frame is configured such that the outer ring 101 and inner ring 102 together form a tubular structure that can house elements that allow the outer ring 101 to rotate with respect to the inner ring 102 when a user/painter rotates the outer ring 101 using his foot as seen in FIG. 15. The outer ring 101 includes a top member 101a and a side member 101b oriented perpendicular to the top member 101a. The side member 101b descends downward from the top member 101a. The inner ring 102 includes a bottom member 102b and a side member 102a oriented perpendicular to the bottom member 102b. The side member 102a ascends upward from the bottom member 102b (FIGS. 11-12).

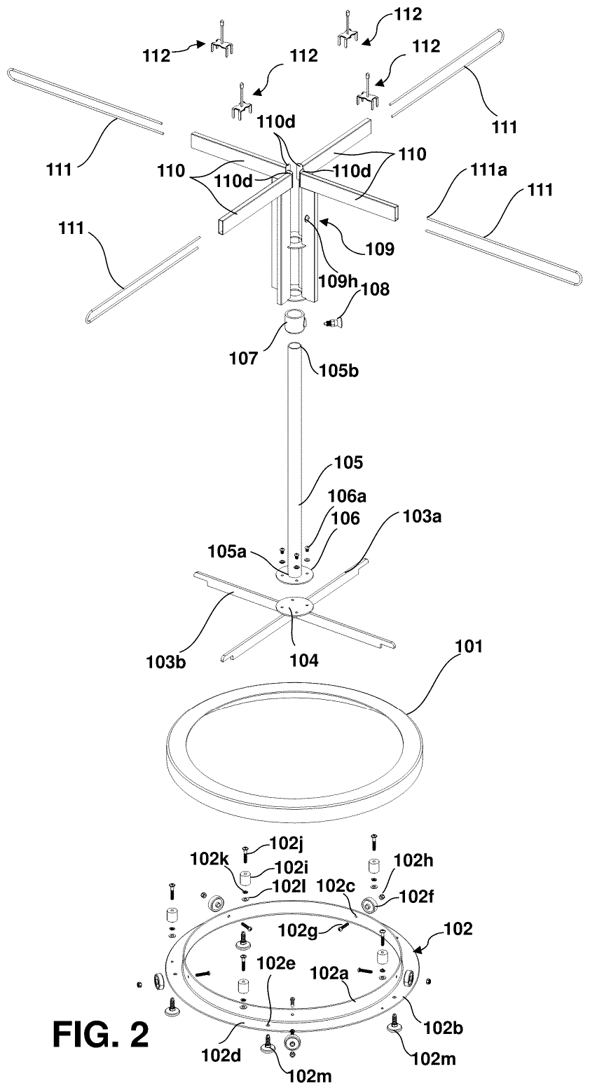

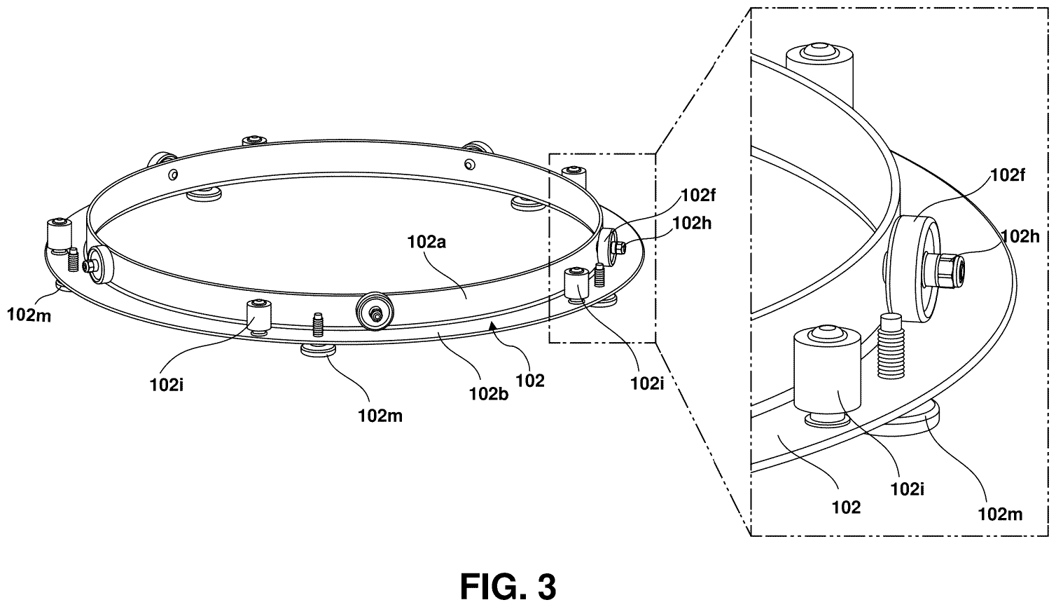

Referring to FIGS. 2-3, the inner ring 102 includes rotatable wheels 102f. In an example, the wheels 102f may be conveyor skate wheels known in the art with bearings inside that facilitate the wheels 102f to spin. The wheels 102f are located spaced apart from each other at a predefined distance along the side member 102a of the inner ring 102. The wheels 102f are configured onto an interior side of the side member 102a as seen in FIG. 3. Each of the wheels 102f is mounted onto the side member 102a using a bolt 102g and a lock nut 102h. In assembly, the bolt 102g passes through a hole 102c located on the side member 102a of the inner ring 102 from an exterior side, and a lock nut 102h is then rotatably engaged to the bolt 102g for retaining the wheel 102f (mounted onto the bolt) in place as may be understood from FIGS. 2-3. In assembly, the outer ring 101 is rotatably mounted on the wheels 102f. Further, as best seen in FIG. 3, the wheels 103 are positioned closer enough to the side member 102a for enhanced load bearing capability and stability of the base frame 101,102. Also, the wheels 102f are mounted such that they do not touch the bottom member 102b of the inner ring 102, which ensures no friction is generated during the operation of the wheels 102f.

Referring to FIGS. 2-3 again, the inner ring 102 further includes rotatable bumpers 102i configured onto the bottom member 102b. Each of the bumpers 102i is mounted onto the bottom member 102b of the inner ring 102 using a bolt 102j that passes through a second hole 102d, and a nut and a lock washer 102k, 102l that engage the bolt 102j. The bumpers 102i are strategically positioned within the tubular structure or the base frame 101,102 (or in other words, mounted onto the bottom member 102b) enabling the outer ring 101 to freely rotate with respect to the inner ring 102 and ensuring the outer ring 101 always remains centered, and does not wobble during rotation. In assembly, the bumpers 102i are configured such that the outer surface of the bumpers 102i remains within the side member 101b of the outer ring 101 and does not touch the side member 101b of the outer ring 101, when the outer ring 101 is not rotating. In operation, each time the outer ring 101 rotates and tries to wobble (due to centrifugal force) during rotation, the side member 101b of the outer ring 101 comes in contact with the bumpers 102i (capable of rotating) creating a friction. This ensures the outer ring 101 gets centered again with respect to the inner ring 102, and the rotating operation continues. The bumper may preferably be a nylon bumper such as for example sold by vendor AP Products (Part #: 013-091). The bumpers 102i are cylindrical and vertically oriented as seen in FIGS. 2-3. The wheels 102f and bumper 102i are preferably made of zinc-plated steel; however use of other materials is possible.

Referring to FIGS. 2-3 again, the inner ring 102 further includes leveling feet 102m. Each leveling foot 102m is configured onto the bottom member 102b of the inner ring 102. The leveling feet are threaded so that they can rotatably fit into threaded holes 102e located on the bottom member 102b of the inner ring 102. The leveling feet 102m may be further secured in place using a nut. Although the invention can be implemented without the leveling feet 102m, the leveling feet 102m play an important role when the assembly is made to stand on an uneven surface. In operation, these leveling feet 102m can be easily rotatably adjusted based on the surface to make the assembly 100 stand flat without shaking on an uneven surface.

Referring again to FIGS. 11-12, the outer ring 101 includes a pair of cross members 103a, 103b configured thereon. Each of these cross members 103a, 103b are V-shaped and welded at the meeting point of two diverging arms as best seen in FIG. 12. Ends of each diverging arms of the cross members 103a, 103b are lasered (laser cut) and welded over an upper surface of the top member 101a of the outer ring 101. A disc 104 is welded onto the cross members 103a, 103b to allow mounting/supporting of a pole 105.

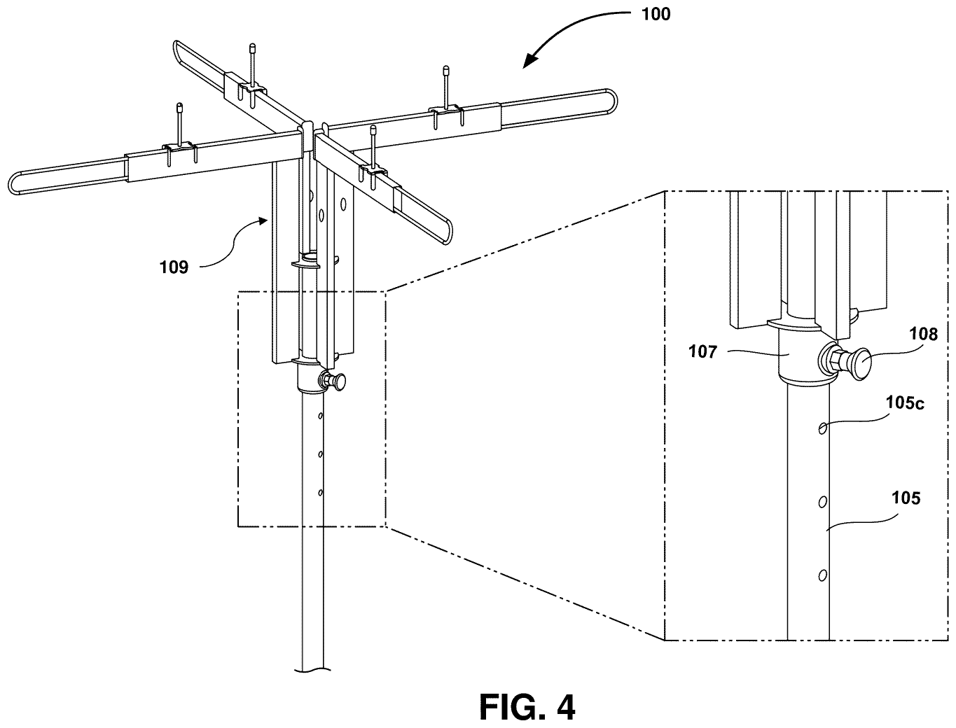

Referring to FIGS. 1-2, the door painting assembly 100 further includes the pole 105 oriented upright over the outer ring 101. The pole 105 includes a first end 105a and a second end 105b. The first end 105a of the pole 105 embodies a flange 106 attached thereto that's bolted onto the disc 104 of the outer ring 101. The flange 106 attaches to the disc 104 welded on top of the cross members 103a, 103b to orient the pole 105 upright over the base frame 101,102. In an embodiment as seen in FIGS. 1-2, the flange 106 and the disc 104 are removably attached using fasteners 106a (such as screws, bolts). In some other embodiments, they may be magnetically coupled. In some other embodiment, they may be welded together for fixed attachment. The pole 105 includes a set of linearly arranged holes 105c (FIG. 4) on one face in proximity to the second end 105b.

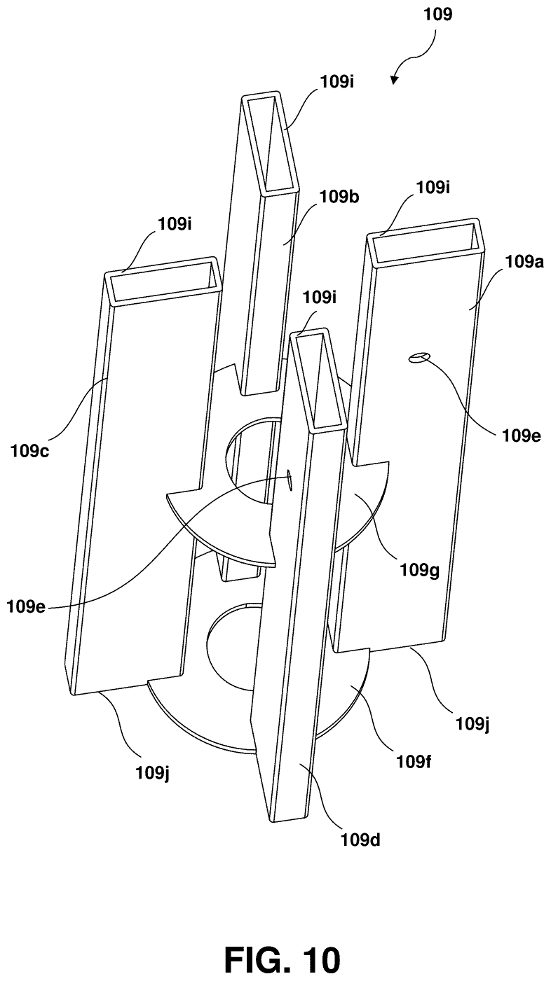

Referring to FIGS. 1-2, 4-6, and 10, the door painting assembly 100 further includes an arm holder assembly 109. The arm holder assembly 109 includes tubes 109a-109d, and circular sleeves 109f, 109g. In an embodiment, as seen in FIG. 10, each of the sleeves 109f, 109g is lasered and welded to the tubes 109a-109d. The arm holder assembly 109 is attached to a plunger assembly 107 having a plunger 108. In an embodiment, the arm holder assembly 109 is welded to the plunger assembly 107 as a single unit. In some other embodiment, the arm holder assembly 109 and the plunger assembly 107 may be removably attached. The plunger 108 is a spring-loaded quick release plunger known in the art. The arm holder assembly 109 and the plunger assembly 107 are together able to slide over the pole 105 to facilitate height adjustment of a mounting surface onto which a door to be painted is mounted. In operation, one can pull the plunger 108 in the outward direction to slide the arm holder assembly 109 to the desired height, align the plunger's pin to a hole and then release the plunger 108 so that the plunger 108 snaps into an aligned hole 105c from the set of linearly arranged holes 105c provided on the pole 105.

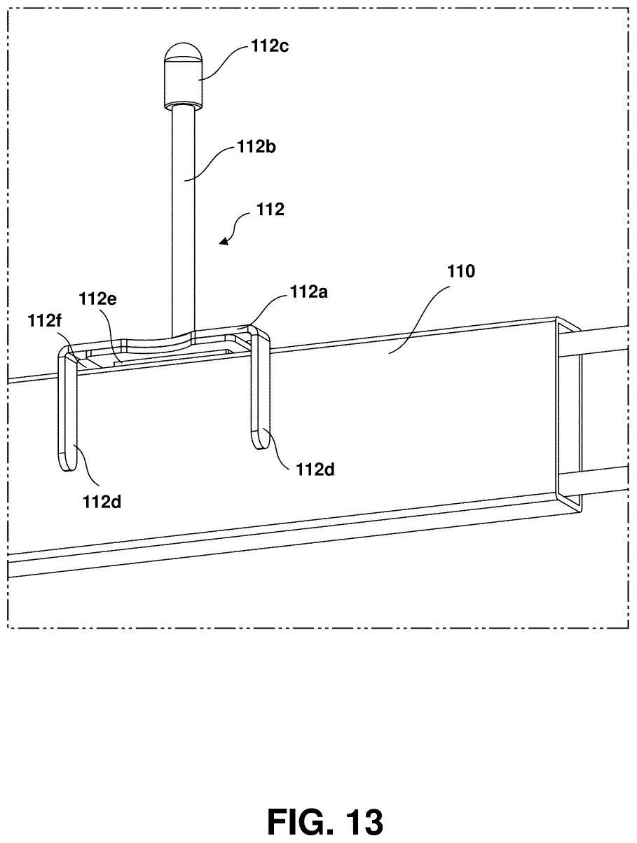

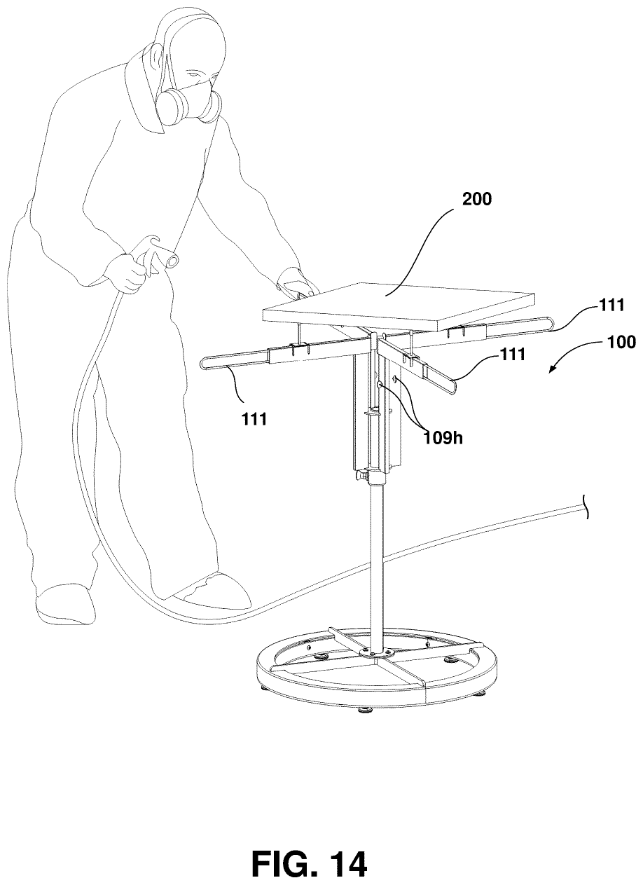

The mounting surface for a door to be painted, according to one embodiment includes a plurality of arms 110 and a plurality of spikes 112, each slidably mounted onto the arms 110. Each of the arms 110 includes a horizontal member 110a and a vertical member 110b. The vertical member 110b includes a threaded slot 110c. The vertical member 110b of each of the arms 110 is slidably insertable into the tubes 109a-109d of the arm holder assembly 109 and locked in place by passing a thumb screw 109h through a through hole 109c provided in each of the tubes 109a-109d, and the threaded slot 110c of the arm 110. As seen in FIGS. 1-2, 13, specifically FIG. 13, each of the spikes 112 includes a body 112a with legs 112d. There is a magnet 112e located underneath the body 112a of the spike 112. A post 112b with a latex tip 112c mounted onto the top surface of the body 112a. Each of the spikes 112 includes a groove 112f that enables the spike to slide over the arm 110 and be adjusted based on the size of the door that needs painting. As seen in FIG. 14, the door 200 to be painted is placed on top of the spikes 112, specifically on the latex tip 112c of the posts 112b. The latex tip 112c of the spikes 112 provides the necessary gripping force and prevents the door from falling out while the door 200 is rotated. The magnet 112e helps the spike 112 to remain securely attached to the arm 110. In some other embodiment, it may be possible that the door 200 may be mounted directly onto the arms 110 (with a necessary grip) instead of using the spikes 112 as described above.

Further, the assembly 100 includes handles 111 that are slidably insertable into the arms 110. The slidable handles 111 are useful in making the arms accessible to the user/painter when painting a substantially larger object. While painting the substantially larger object, one can slide the handles 111 outward within the arms, effectively making the handles “longer,” allowing the user/painter to still access the arms 110. The handles are preferably U-shaped rods as seen in FIGS. 1 and 2. The U-shaped rod is wide open at its free end 111a. In operation, the handle 111 is squeezed or flexed using hands and slidably inserted inside the arms 110, specifically into the horizontal member 110a as seen in FIG. 1. Once inserted into the horizontal member 110a of the arm 100, the free end 111a of the handle 111 gets locked against walls of the horizontal member 110a of the arm 100. These handles 111 help a painter/user to rotate the door 200 placed on top of the mounting surface/supporting surface using his/her one hand (while holding the spray gun on other hand) as seen in FIG. 14 rather than rotating the door 200 using their foot as described above and shown in FIG. 15 (made possible by the rotatable outer ring 101). The outer ring 101 rotates regardless of whether the user/painter uses his hand or his foot to rotate the assembly.

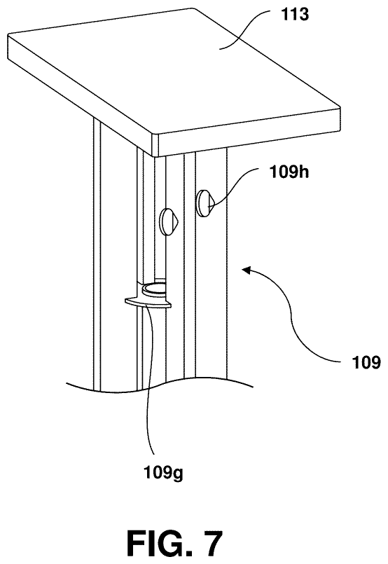

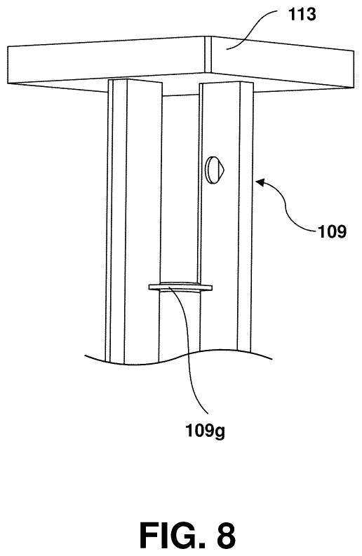

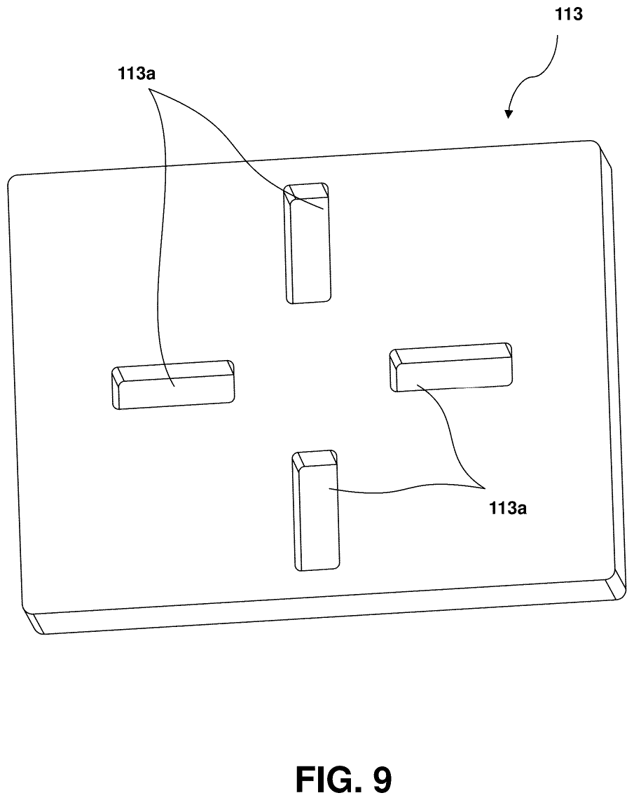

In an alternative embodiment, as shown in FIGS. 7-8, the mounting surface for the door 200 to be painted can be a block member 113 instead of the combination of arms, spikes, and handles described above and illustrated in FIGS. 1, 14-15. As seen in FIGS. 7-8, the block member 113 may be configured in the form of an MDF board (Medium Density Fiberboard) of suitable size. As seen in FIG. 9, the MDF board 113 comprises a plurality of notches/grooves 113a formed underside (bottom surface) of the MDF board 113. The MDF board 113 with notches 113a rests over the top end 109i of the tubes 109a-109d of the arm holder assembly 109. In assembly, the notches/grooves 113a are sized such as to receive the top end 109i of the tubes 109a-109d and ensure the MDF board 113 remains intact on top of the tubes 109a-109d of the arm holder assembly (109). The painter/user can place the door to be painted on top of the MDF board 113. In this embodiment, the user/painter can ideally rotate the door to be painted using their foot instead of using handles.

Thus, the door painting assembly 100 can be configured to have two different mounting or supporting surfaces as described above. Firstly, the mounting surface formed by the use of arms, spikes, and handles, all configured onto the arm holder assembly (109), and secondly using the block member 113 or the MDF board on top of the tubes 109a-109d of the arm holder assembly (109). Depending on the size of the door to be painted, one can choose the best options for them to use. In use, the user of arms and spikes is better suited for larger paint surfaces or bigger objects, whereas the MDF board 113 is best suited for smaller spray surfaces or smaller objects. Also, whether the supporting surface is formed with the spikes 112 or a small MDF surface 113, they raise the edges of the object/cabinet door off of a supporting/mounting surface, thereby reducing the swirling air that creates uneven paint coverage.

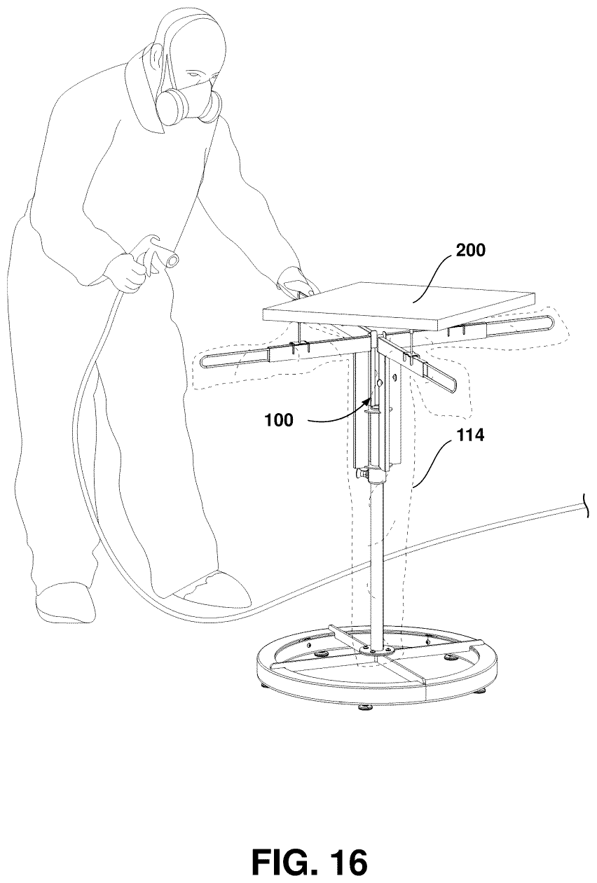

FIG. 16 shows the rotatable door painting assembly of FIG. 1 in use, with a polybag covering the underside portions of the door painting assembly. In assembly, as seen in FIG. 16, before the arms 110 are configured in the arm holder assembly 109, the user/painter can slide in a very thin polybag 114 over the tubes 109a-109d of the arm holder assembly 109 and the pole 105. Next, the arms 110 are slidably inserted into the tubes 109a-109d, thereby covering the underside portion (the tubes 109a-109d and the pole 105) of the assembly 100. Further, one can individually slide in polybags 114 onto the arms as well to cover the arms 114. The possibility of use of polybags safeguards the assembly from oversprayed paint while spraying the doors mounted on the assembly 100. The tubes 109a-109d and sleeves 109f-109g of the arm holder assembly 109 allow polybag uses that prevent overspray from gunking up the parts/components (such as the pole 105, the plunger assembly (107), the plunger (108) etc) located underneath the spray table.

Although particular embodiments of the invention have been described in detail for purposes of illustration, various modifications, and enhancements may be made without departing from the spirit and scope of the invention.

1. A door painting assembly (100), comprising:
a base frame (101,102) comprising:
an outer ring (101) having a top member (101a) and a first side member (101b) oriented perpendicular to the top member (101a);
an inner ring (102) having a bottom member (102b) and a second side member (102a) oriented perpendicular to the bottom member (102b);
wherein the outer ring (101) is rotatably configured over the inner ring (102) ensuring the outer ring (101) remains centered with respect to the inner ring (102) during rotation;
a pole (105) oriented upright over the outer ring (101) comprising a first end (105a), a second end (105b), a set of linearly arranged holes (105c) located in proximity to the second end (105b); and
an arm holder assembly (109) comprising a plurality of tubes (109a-109d), a plurality of sleeves (109f, 109g), wherein the arm holder assembly (109) is attached to a plunger assembly (107) with a plunger (108) and wherein the arm holder assembly (109) is slidable over the pole (105) to facilitate height adjustment of a door (200) mounted over a supporting surface.

2. The door painting assembly (100) of claim 1, wherein the inner ring (102) comprises a plurality of rotatable wheels (102f) configured onto the second side member (102a).

3. The door painting assembly (100) of claim 2, wherein each of the plurality of rotatable wheels (102f) is mounted onto the second side member (102a) using a bolt (102g) that passes through a first hole (102c), and a lock nut (102h) that engages the bolt (102g).

4. The door painting assembly (100) of claim 2, wherein the plurality of rotatable wheels (102f) are conveyor skate wheels onto which the outer ring (101) is rotatably mounted.

5. The door painting assembly (100) of claim 1, wherein the inner ring (102) comprises a plurality of rotatable bumpers (102i) configured onto the bottom member (102b).

6. The door painting assembly (100) of claim 5, wherein each of the plurality of rotatable bumpers (102i) is mounted onto the bottom member (102b) of the inner ring (102) using a bolt (102j) that passes through a second hole (102d), and a nut and a lock washer (102k,102l) that engages the bolt (102d).

7. The door painting assembly (100) of claim 5, wherein each of the plurality of rotatable bumpers (102i) is mounted onto the bottom member (102b) enabling the outer ring (101) to freely rotate with respect to the inner ring (102) and ensuring the outer ring (101) always remains centered, and does not wobble during rotation.

8. The door painting assembly (100) of claim 1, wherein the inner ring (102) further comprises a plurality of levelling feet (102m), each configured onto the bottom member (102b) of the inner ring (102) to ensure the door painting assembly (100) stands flat on an uneven surface.

9. The door painting assembly (100) of claim 1, wherein the outer ring (101) further comprises a pair of cross members (103a, 103b) configured thereon.

10. The door painting assembly (100) of claim 9, wherein each of the cross members (103a, 103b) is V-shaped and welded at the meeting point of two diverging arms and lasered and welded over an upper surface of the top member (101a) of the outer ring (101).

11. The door painting assembly (100) of claim 1, wherein the first end (105a) of the pole (105) embodies a flange (106) that's attached to a disc (104) attached on top of the pair of cross members (103a, 103b).

12. The door painting assembly (100) of claim 1, wherein each of the plurality of sleeves (109f, 109g) of the arm holder assembly (109) is lasered and welded to the plurality of tubes (109a-109d).

13. The door painting assembly (100) of claim 1, wherein the supporting surface for the door (200) comprises
a plurality of arms (110), each arm (110) having
a horizontal member (110a);
a vertical member (110b) with a threaded slot (110c), wherein the vertical member (110b) of each of the plurality of arms (110) is insertable into the plurality of tubes (109a-109d) of the arm holder assembly (109) and locked in place by passing a thumb screw (109h) through a through hole (109e) provided in each of the plurality of tubes (109a-109d) and the threaded slot (110c); and
a spike (112) comprising a body (112a) with a plurality of legs (112d), a magnet (112e) located underneath the body (112a), a post (112b) with a latex tip (112c) mounted onto a top surface of the body (112a), wherein the spike (112) comprising a groove (112f) that enables the spike (112) to slide over the arms (110) and be adjusted based on the size of the door (200) that needs painting.

14. The door painting assembly (100) of claim 1 further comprising a plurality of handles (111), each of handle (111) is slidably insertable into the horizontal member (110a) of the arm (110) and facilitates rotation of the door (200) mounted over the supporting surface.

15. The door painting assembly (100) of claim 14, wherein each of the handle (111) is a U-shaped rod with a wide-open free end (111a) that's slidably insertable inside the arms (110) and that can be selectively moved outward making the handles (111) “longer,” to allow a painter to access the arms (110) while painting substantially larger doors.

16. The door painting assembly (100) of claim 1, wherein the supporting surface for the door (200) comprises a block member (113) comprising a plurality of notches (113a) formed underside the block member (113).

17. The door painting assembly (100) of claim 16, wherein the block member (113) is an MDF board and the plurality of notches (113a) receive the top end (109i) of the plurality of tubes (109a-109d) when the MDF board is placed thereon.

18. A door painting assembly (100), comprising:
a base frame (101,102) comprising:
an outer ring (101) having a top member (101a) and a first side member (101b) oriented perpendicular to the top member (101a);
an inner ring (102) having a bottom member (102b) and a second side member (102a) oriented perpendicular to the bottom member (102b);
wherein the outer ring (101) is rotatably configured over the inner ring (102) ensuring the outer ring (101) remains centered with respect to the inner ring (102) during rotation;
a pole (105) oriented upright over the outer ring (101) comprising a first end (105a), a second end (105b), a set of linearly arranged holes (105c) located in proximity to the second end (105b);
an arm holder assembly (109) comprising a plurality of tubes (109a-109d), a plurality of sleeves (109f, 109g), wherein the arm holder assembly (109) is attached to a plunger assembly (107) with a plunger (108) and wherein the arm holder assembly (109) is slidable over the pole (105) to facilitate height adjustment of a door (200) mounted over a supporting surface;
a plurality of arms (110) slidably insertable into the plurality of tubes (109a-109d) of the arm holder assembly (109), each of the arms (110) having a horizontal member (110a), and a vertical member (110b); and
a spike (112) slidably configurable on each of the plurality of arms (110), the spike (112) comprising a body (112a) with a plurality of legs (112d), a magnet (112e) located underneath the body (112a), and a post (112b) with a tip (112c) mounted onto a top surface of the body (112a).

19. The door painting assembly (100) of claim 18, wherein the spike (112) comprises a groove (112f) that enables the spike (112) to slide over the arms (110) and be adjusted based on the size of the door (200) that needs painting.

20. The door painting assembly (100) of claim 18, wherein the vertical member (110b) of each of the plurality of arms (110) comprises a threaded slot (110c) and the vertical member (110b) is insertable into the plurality of tubes (109a-109d) of the arm holder assembly (109) and locked in place by passing a thumb screw (109h) through a through hole (109e) provided in each of the plurality of tubes (109a-109d) and the threaded slot (110c).
